(19) United States
(12) Patent Application Publication
(10) Pub. No.: US 2011/0033347 A1
(43) Pub. Date: Feb. 10, 2011

(54) OXIDATION REACTOR FOR MANUFACTURING OF CRUDE TEREPHTHALIC ACID

(76) Inventors: Hyungjin Kim, Seoul (KR); Hansan Kim, Seoul (KR); Sungwo Chai, Seoul (KR)

Correspondence Address: HAMMER & ASSOCIATES, P.C., 3125 SPRINGBANK LANE, SUITE G, CHARLOTTE, NC, 28226, US

(21) Appl. No.: 12/937,550

(22) PCT Filed: Mar. 19, 2009
(86) PCT No.: PCT/KR09/01391

§ 371 Date: Oct. 13, 2010

(30) Foreign Application Priority Data
Apr. 16, 2008 (KR) 10-2008-0035247

(51) Int. Cl. B01J 19/18

(52) U.S. Cl. 422/229

(57) ABSTRACT

Disclosed is an oxidation reactor for manufacturing terephthalic acid (CTA). In particular, in connection with manufacturing CTA by oxidizing para-xylene in the presence of air containing oxygen and acetic acid solvent, the present invention relates to location relationship among a gas reactant feeding location to feed air containing oxygen, a liquid reactant feeding location to feed para-xylene and a location of an impeller, and also relates to a new oxidation reactor, a structure of which is changed.

The oxidation reactor of the present invention controls location relationship among a gas reactant feeding location, a liquid reactant feeding location and a location of an impeller in consideration of a flowing pattern of gas reactant and liquid reactant and a distribution of formed CTA, thereby performing a reaction without a dead zone in the reactor, thus manufacturing CTA in a higher forming rate than before.

### TECHNICAL FIELD

The present invention relates to a reactor for manufacturing crude terephthalic acid. In particular, in connection with manufacturing crude terephthalic acid by oxidizing para-xylene in the presence of air containing oxygen and an acetic acid solvent, the present invention relates to location relationship among a gas reactant feed pipe to feed air containing oxygen, a liquid reactant feed pipe to feed para-xylene and an impeller, and also relates to a new oxidation reactor, a structure of which is changed.

### BACKGROUND ART

Terephthalic acid (TA) is a starting material to polymerize polyethylene threphtalate which is a major polymer of polyester fiber, polyester film, bottles, and resin for other containers. The polyester fiber is used in textile goods and for industrial use as well, such as tire code, and the polyester film being coated with adhesive or emulsion is useful for wrapping tape, photographic film, and recording tape.

In a conventional preparation of TA, it is well known that para-xylene is oxidized by an oxygen molecule in acetic acid solvent in the presence of a catalytic system based on catalyst containing bromine and a heavy metal including cobalt, manganese, and the like.

Although the conventional method has a variety of superiorities in industrial preparation of TA, there are problem which a basic unit of the solvent is increased since loss of acetic acid used as a solvent occurs during a reaction, and an undesirable side reaction product is formed.

Loss of the acetic acid used as a solvent occurs in a burning phenomenon when the acetic acid directly reacts with a gaseous reactant, such as oxygen, and burns, or when Methyl acetate is additionally formed.

That is, in order to produce TA, the following main reaction should occur,

Para-xylene+Oxygen→TA.

However, the acetic acid used as a solvent is oxidized and the following side reactions occurs, resulting in the loss of acetic acid.

Acetic acid+Oxygen→Methyl acetate

or

Acetic acid+Oxygen→Carbon dioxide+water.

The causes of acetic acid oxidation phenomenon are an inner structure of a reactor, low stirring effect, and competitive reaction which occurs because oxidation conditions of the acetic acid and that of the para-xylene are similar to each other. Thus, it is well known that minimizing contact between acetic acid and air is the best way to prevent oxidation of the acetic acid.

Also, according to the above described preparation method, TA may include a lot of impurities which cause coloration such as 4-carboxybenz-aldehide (4-CBA), and para-toluic acid. Therefore, there is a problem that a high-level refining technique is required in a post process to obtain a high degree of purity of TA.

Specifically, the 4-CBA and para-toluic acid which are intermediates formed in the preparation process of TA have only one functional group, unlike the TA, so that they are known as typical organic impurities for terminating a polymerization reaction in the polymerization process.

When concentration of the 4-CBA is not maintained under 250 ppm in TA, the 4-CBA may perform as a reaction terminator in polycondensation reaction. Therefore, there is problem that high molecular weight of polyester may not be obtained.

### DISCLOSURE OF INVENTION

### Technical Goals

An aspect of the present invention provides an optimum oxidation reactor which can control location relationship among gas reactant feeding location, liquid reactant feeding location and a location of an impeller in consideration of a flowing pattern of a gas reactant and a liquid reactant and a distribution of formed of crude terephthalic acid (CTA). Thus, stirring effect is increased inside the reactor, so that an intermediate is reduced, the production yield is increased, and oxidation of acetic acid used as a solvent is reduced.

### Technical Solutions

According to an aspect of the present invention, there is provided a sequencing batch para-xylene oxidation reactor for preparation of terephthalic acid including a shaft located in the center of the reactor, an upper impeller installed in the shaft installed in the shaft to perform rotation, a lower impeller installed in the shaft to perform rotation and located between the upper impeller and a bottom of the reactor, a liquid reactant feed pipe to feed liquid reactant to the reactor, a gas reactant feed pipe to feed gas reactant to the reactor, and a product exhaust pipe to exhaust a slurry formed inside the reactor, wherein a center of a section of an end of the liquid reactant feed pipe is located in the same height as a center of a section of an end of the gas reactant feed pipe from a lower part of the reactor.

Also, the center of the section of the liquid reactant feed pipe end and the center of the section of the gas reactant feed pipe end are located in a concentrated stirring region of the lower impeller.

Also, a ratio of a height difference between the upper impeller and the lower impeller to a diameter of the upper/lower) impeller is between 1.0 and 1.5.

In an aspect of the reactor of the present invention, a ratio of a diameter of the upper/lower impeller to diameter of the reactor is between 0.4 and 0.5.

In an aspect of the reactor of the present invention, a ratio of a height of the lower impeller from the bottom of the reactor to a diameter of the lower impeller is equal to or more than 0.5.

In an aspect of the reactor of the present invention, a ratio of a height of the product exhaust pipe (from the bottom of the reactor) to a height difference between the upper impeller and the lower impeller is between 1.2 and 1.5.

In an aspect of the reactor of the present invention, an extension line of the liquid reactant pipe end contacts with a virtual circle formed in a diameter (D) of the lower impeller.

In an aspect of the reactor of the present invention, an extension line of the gas reactant pipe end contacts with a virtual circle formed in a diameter (D) of the lower impeller.

In an aspect of the reactor of the present invention, the reactor further includes a reflux pipe to introduce reflux to the inside the reactor, wherein a height of a center of a section of an end of the reflux pipe is the same as both a height of a center of a section of the liquid reactant feed pipe end and a height of a center of a section of the gas reactant feed pipe end.

Referring to the drawings, the best mode for carrying out the present invention is described in detail below.

FIG. 1 illustrates a conventional reactor for preparation of terephthalic acid (TA).

Referring to FIG. 1, a conventional continuously stirred oxidation reactor tank includes a liquid reactant feed pipe 10 that is located in an upper part of the reactor and a gas reactant pipe 20 that is located in a lower part of the reactor. Liquid reactant is fed from the upper part and gas reactant is fed from the lower part, so that oxidation reaction based on a counter-current contact between the liquid reactant and air occurs. That is, the liquid reactant feed pipe is installed around the upper impeller and the gas reactant feed pipe is installed lower than the center of the lower impeller so as to enable the lower impellers to perform stirring as fed gas rises.

However, in the case of the conventional reactor, as gas fed through the lower part moves to the upper part, the gas may react to acetic acid inside the reactor before the gas reacts to para-xylene, and thus oxidation of acetic acid occurs and loss of the acetic acid occurs. Also, in the case of the continuously stirred oxidation reactor tank, theoretically, it works in a normal state, but actually, a dead zone where stirring operation is ineffective is formed inside the reactor, and thus an intermediate, 4-CBA, is formed and the production yield of crude terephthalic acid (CTA) is decreased.

FIG. 2 roughly illustrates a section of an oxidation reactor. According to the present invention, a liquid reactant feed pipe 110 and a gas reactant feed pipe 120 are installed around a lower impeller, so that the liquid reactant, para-xylene, can directly contact to the gas reactant, air, thereby increasing a probability that the para-xylene contacts with the air and decreasing a probability that acetic acid used as a solvent contacts to air. Thus, oxidation of the acetic acid is prevented.

The gas and liquid reactant feed pipes include an introducing unit that introduces a pipe from outside the reactor to the reactor, and a extension unit that extends from the introducing unit to inside the reactor, an end of a feed pipe through which a reactant is fed inside the reactor. In the reaction of the present invention, the feed pipe end through which liquid reactant and gas reactant are actually fed inside the reactor is adjusted.

In an aspect of the reaction of the present invention, the extension unit may be extended horizontally or vertically, depending on a location of the introducing unit that introduces the pipe to the reactor, and also a location of the feed pipe end.

Also, a center of a section of an end of the liquid reactant feed pipe 110 and a center of a section of an end of the gas reactant feed pipe 120 are located in a concentrated stirring region, represented as an A in FIG. 3 (in a range of an upper and lower blade of the lower impeller represented as an “A” in FIG. 3). In this instance, stirring is strongly performed in the same direction as the lower impeller using stirring power caused by the lower impeller, thereby increasing contact area and contact time between air bubbles generated from the impeller and a reactant fed from a feed pipe. Therefore, a rate of conversion to TA is increased.

A number of liquid reactant feed pipes and gas reactant feed pipes are changed depending on a size and capacity of the reactor, however, the pipes are evenly distributed in the reactor and the liquid reactant feed pipe and the gas reactant feed pipe are alternately arranged in direction of pipe's rotation.

In an aspect of the reactor of the present invention, the liquid reactant feed pipe end and the gas reactant feed pipe end are formed to enable extension lines of the pipe ends to contact a virtual circle formed in a diameter (D) of the lower impeller, as shown in FIG. 4. When a reactant feed pipe end is formed to contact a virtual circle formed in a diameter of the lower impeller in a rotation direction of the impeller, stirring is completely performed using stirring power of the impeller.

An impeller is installed in a shaft located in the center of the reactor, in particular, the impeller is installed as a pair as an upper impeller and lower impeller. Also, it is desirable that the impeller is in a flat disc turbine scheme divided into 2 to 4 sectors or a concave type and a blade of the impeller is bent inside the reactor.

When a diameter of an impeller is D, and an interval between an upper and a lower impeller (a height difference between an upper and a lower impeller) is F, it is desirable that a ratio of D to F (F/D) is between 1.0 and 1.5. When the ratio of D to F (F/D) is equal to or less than 1.0, the stirring of the upper impeller and the lower impeller in the center of the reactor may be overlapped with each other, and there is a probability that a dead zone is formed in an upper part and a lower part of the reactor. Moreover, when the ratio is equal to or more than 1.5, there is a probability that the dead zone is formed between the upper impeller and the lower impeller.

It is desirable that a ratio of D to a diameter of reactor (T) (D/T) is between 0.4 and 0.5. When the ratio is equal to or less than 0.4, D is comparatively shorter than T, resulting in a liquid reactant and a gas reactant not being sufficiently stirred. Accordingly, a material transfer constant is decreased and a probability of contact between reactants is decreased. When the ratio is equal to or more than 0.5, although a dead zone is formed around the lower impeller, a reaction region around the upper impeller where rising gas reactant from the lower impeller and the liquid reactant are stirred is reduced.

It is desirable that a ratio of height from the bottom of the reactor to the lower impeller (C) to D is equal to or more than 0.5. When the ratio is equal to or less than 0.5, there is probability that a dead zone is formed in a lower part of the lower impeller.

In the case of the conventional reactor, a product exhaust pipe 40 is located in a lower part of a reactor as shown in FIG. 1. In the present invention, however, a product exhaust pipe 140 is connected to a reactor in an upper part of the reactor as shown in FIG. 2. In this instance, it is desirable that a ratio of a height from a center of the lower impeller to the product exhaust pipe (H) to F (H/F) is between 1.2 and 1.5.

The reactor of the present invention is configured so that a flow of liquid reactant and gas reactant is consecutively provided from the lower part to the upper part. Particularly, although a slurry pipe to exhaust formed slurry is located in upper part, the slurry is not accumulated in the lower part. Finally, a product can be transferred to an entrance of the product exhaust pipe without forming a dead zone in the reactor by regularly maintaining a distribution and the flow of the slurry.

When a ratio of height of the product exhaust pipe to a height difference between the upper impeller and the lower impeller is equal to or less than 1.2 or equal to or more than 1.5, slurry exhausted by stirring power caused by the upper and lower impellers does not completely perform a reaction in the reactor, resulting in an intermediate being formed. When the ratio is between 1.2 and 1.5, slurry that is completely stirred in the reactor is exhausted.

Also, since the conventional reactor extracts a formed CTA in the lower part of the reactor, highly concentrated para-xylene provided from the upper part of the reactor is exhausted as gas and flowed into a reflux system, and causes a burden on a distiller system. Therefore, the conventional reactor has a problem that utility cost is increased. However, since the present invention extracts the CTA from the upper part of the reactor, the above-mentioned problem may be solved.

In an aspect of the reactor of the present invention, the reactor may further include a reflux pipe.

Reflux, condensing components evaporated from the reactor as vapor passes through a condenser and providing the same inside the reactor, is comprised of 78% acetic acid and 22% water at a temperature of 157° C. The conventional reflux pipe 30, as shown in FIG. 1, is introduced from the upper reactor to the reactor and is extended to the lower part inside the reactor.

The reflux pipe, as the gas reactant feed pipe and the liquid reactant feed pipe of the present invention, includes an introducing unit that is introduced from outside of the reactor to the reactor, a extension unit that extends inside the reactor, and an end of a reflux pipe through which a reflux is fed to the reactor. Also, as shown in FIG. 2, a center of a section of the reflux pipe end 130 is installed at the same height as the center of the section of the gas reactant feed pipe and that of the liquid reactant feed pipe. In this instance, since a temperature of the acetic acid and water fed to the reflux pipe is lower than that of reactant inside the reactor, fast burning inside the reactor is decreased. That is, in the case of the present invention, although the temperature of the reactor may rapidly rise as the liquid reactant and the gas reactant are fed from the same height of the reactor and perform a reaction, installation of the reflux pipe in the same height may prevent the rapid rise of temperature so as to hinder oxidation of the acetic acid used as a solvent.

Next, a crystallizing process and separating process to separate formed crystal from the liquid reactant are required, since a product of the oxidation process is obtained in a form of slurry including TA powder.

An obtained CTA is refined through a refining process, such as dissolving, oxidation, and reduction and the refined TA is crystallized, and then slurry containing a crystallization is obtained.

A variety of methods for refining the crude TA obtained from liquid oxidation reaction according to the present invention are well known, such as a method of melting the CTA in a water solvent under high temperature and high pressure and then performing contact with hydrogen, oxidation, or re-crystallization and a method of a high temperature dissolving of slurry where a portion of TA crystallization is melted. Specifically, a method of melting the CTA in water under high temperature and high pressure, and then performing contact with hydrogen in the presence of a group VIII noble metal catalyst is a large scale process for manufacturing high purity of TA, which has been used over the decades.

A generally used crystallization method is a method of washing the obtained slurry with water or acetic acid. The washed slurry contains TA in suspended form. From the suspension, a solid component is obtained by separating liquid from solid. Then, the obtained solid component is dried and finally TA is obtained.

The reactor of the present invention is described in light of gas-liquid oxidation reaction for preparing CTA. However, it can also be applied to general gas-liquid oxidation reaction. Also, it can be applied to a formation reaction for CTA using para-xylene and a formation reaction for CTA using meta-xylene, ortho-xylene as well.

### BRIEF DESCRIPTION OF DRAWINGS

FIG. 1 is a vertical cross-sectional view of a conventional oxidation reactor;

FIG. 2 roughly illustrates a section of an oxidation reactor of the present invention;

FIG. 3 is a cross-sectional view illustrating a location relation between a liquid or gas reactant feed pipe and a lower impeller;

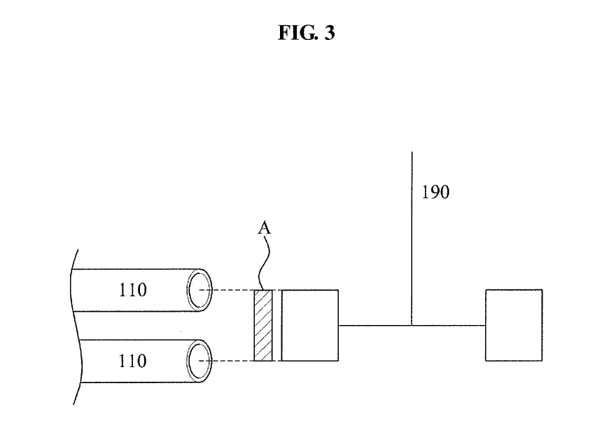

FIG. 4 is cross-sectional view of an inside of an oxidation reactor according to the present invention;

FIG. 5 is a result of measuring a mass fraction of an intermediate, 4-carboxybenz-aldehide (4-CBA) based on height;

FIG. 6 is a result of measuring a mass fraction of para-xylene to a total mass based on height; and

FIG. 7 is a result of measuring an amount of oxidation of a solvent, acetic acid, based on height.

### BEST MODE FOR CARRYING OUT THE INVENTION

Although a few exemplary embodiments of the present invention have been shown and described, the present invention is not limited to the described exemplary embodiments.

### EXAMPLE 1

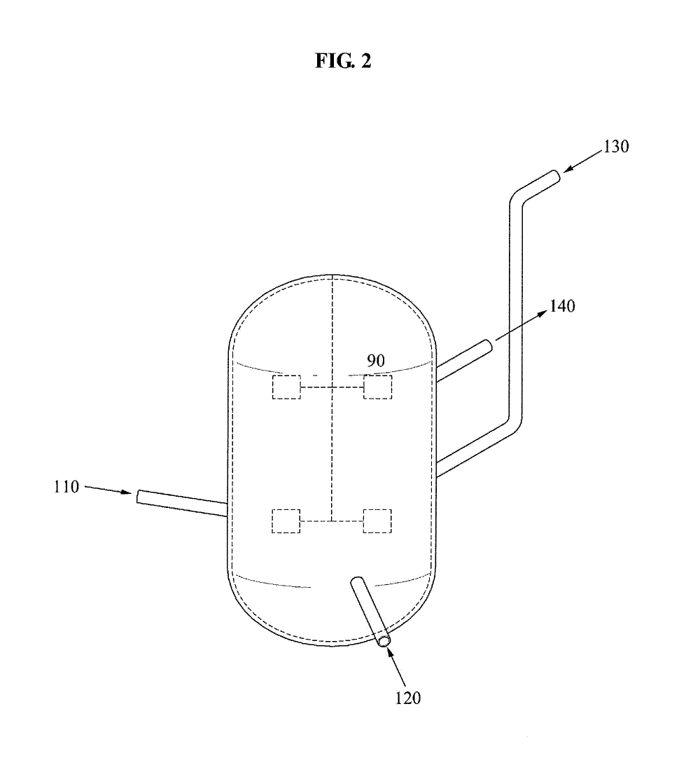

Example 1 is simulated for a reactor under a condition illustrated in FIG. 2.

An impeller having a 2100 mm diameter and 6 blades, and comprised of three sectors was installed as a pair in a shaft. A height (C) from a bottom of the reactor to a center of a lower impeller was 1555 mm, and a difference (F) between an upper impeller and the lower impeller was 2700 mm. The shaft rotated clockwise at 80 rpm and a height (H) from the center of the lower impeller to a product exhaust pipe was 4000 mm.

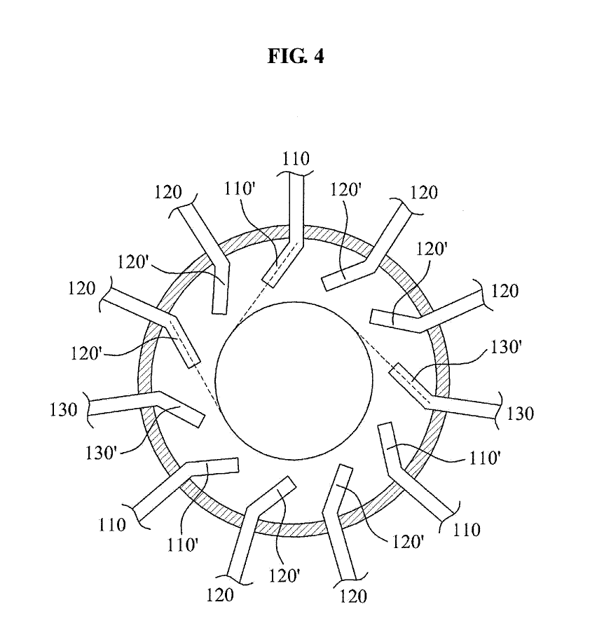

FIG. 4 is a top view of an inside of the reactor used in the example embodiment 1.

As shown in FIG. 4, a para-xylene, namely a liquid reactant feed pipe 110 with a 2100 mm diameter was arranged toward a starting point from an outside of the reactor at 120 degree intervals, 120 degrees being measured from the plane, and introduced through an introducing unit. Also, the liquid reactant feed pipe 110 was installed to enable a center of a section of an end of the pipe to be located within 100 mm from the center of a lower impeller blade. Inside the reactor, an extension unit 110′ connecting the introducing unit to the pipe end was formed to enable the liquid reactant feed pipe end to be extended until the pipe end had a 100 mm interval from the lower impeller.

The liquid reactant feed pipe end was not installed toward to a center of a circle, but the pipe was installed to enable an extension line of the pipe end to be in a direction of a contact line of a virtual circle formed by the impeller.

Air containing oxygen was transferred to a gas reactant feed pipe 120. As shown in FIG. 4, six gas reactant feed pipes were installed in total, every two of which were installed between the liquid reactant feed pipes.

Also, after the gas reactant feed pipe 120 was introduced to the reactor, an extension unit was formed to enable the gas reactant feed pipe end to be extended until the pipe end was a 100 mm apart from the impeller. The gas reactant feed pipe end was not installed toward to a center of a circle, but the pipe was installed to enable an extension line of the pipe end to be in a direction of a contact line of the virtual circle formed by the lower impeller. The gas reactant feed pipe was installed to enable a center of a section of the pipe end to be located 100 mm under the center of a lower impeller blade.

A reflux pipe 130 transferred a reflux at 157° C. to the reactor. Two reflux pipes were installed and they were introduced at 180 degree intervals to the reactor. An end of the reflux pipe was finished with a 90 degree elbow, and the reflux pipe end was installed to have a tilt in a direction of rotation so that the extension of the pipe end had a direction of a contact line of a virtual circle formed by the lower or the upper impeller. The reflux pipe end was installed to enable the center of the section of the reflux pipe end to be the same height as the center of the section of the liquid reactant pipe end and the section of the gas reactant pipe end.

A formed slurry was transferred through a product exhaust pipe 140 located 4000 mm above the center of the lower impeller.

### EXAMPLE 2

An impeller having a 2100 mm diameter and 6 blades divided into three sectors was installed in an upper and a lower part of a shaft. A height (C) from a bottom of the reactor to a center of a lower impeller was 1800 mm, a difference (F) between an upper impeller and the lower impeller was 3100 mm, and a height (H) from the center of the lower impeller to a product exhaust pipe was 3800 mm.

As shown in FIG. 4, a para-xylene, namely a liquid reactant feed pipe with a 2750 mm diameter was arranged toward a starting point from an outside of the reactor at 120 degree intervals, the 120 degrees being measured from the plane, and an introducing unit was installed in an upper part of the reactor. Inside the reactor, an extension unit of the liquid reactant feed pipe end was formed in the vertical up to the height that the center of the section of the liquid reactant feed pipe end corresponds to the center of the blade of the lower impeller. Also, a portion connected to the pipe end was bent to form a 90 degree elbow and installed until the pipe end was a 100 mm apart from the impeller.

Air containing oxygen was transferred to a gas reactant feed pipe 120. As shown in FIG. 4, six gas reactant feed pipes were installed in total, and every two of which were installed between the liquid reactant feed pipes.

Also, after the gas reactant feed pipe 120 was introduced to the reactor through an introducing unit located in the lower part of the reactor, an extension unit 120′ inside the reactor was installed until the pipe end was 100 mm apart from the impeller. An extension unit of the gas reactant feed pipe was installed to have a direction of a contact line of virtual circle formed by the lower impeller. A center of a section of an end of the gas reactant feed pipe is located 100 mm under the center of a lower impeller blade.

A reflux pipe 230 transferred a reflux using 157° C. of pressure difference. Two reflux pipes were installed and located at 180 degree intervals. An end of the reflux pipe was extended from the introducing part of the reflux pipe in the vertical, and finished with a 90 degree elbow. The reflux pipe end was installed at the same height as the center of the section of the liquid reactant feed pipe end and the center of the section of the gas reactant feed pipe end. Also, the reflux pipe end was installed to enable the extension of the pipe end to contact to a circumference of the virtual circle formed by the impeller.

A formed slurry was exhausted through an a product exhaust pipe located 3800 mm above the center of the lower impeller.

### Comparative Example 1

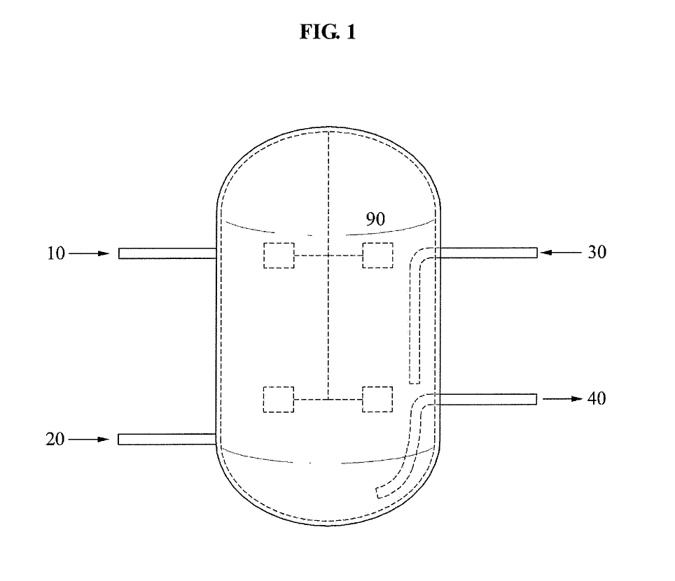

A conventional reactor as illustrated in FIG. 1 was used. Also, as roughly shown in FIG. 1 a liquid reactant feed pipe introducing unit and an liquid reactant feed pipe end were installed around an upper impeller of an upper part of the reactor, a gas reactant feed pipe introducing unit and a gas reactant feed pipe end were installed in a lower part of the reactor, and a product exhaust pipe was installed in lower part of the reactor.

### Comparative Example 2

Comparative Example 2 was simulated under the same condition as Example 1, except that a difference between an upper and lower impeller was set to 2000 mm and a ratio of a diameter of the upper/lower impeller to the difference between the upper and lower impeller was set to 0.95.

With respect to the above described reactors of Example 1, Comparative 1 and 2, the following experiments were performed using a CFD-fluent simulation program.

<Measuring a Ratio of an Intermediate, 4-Carboxybenz-Aldehide (4-CBA)>

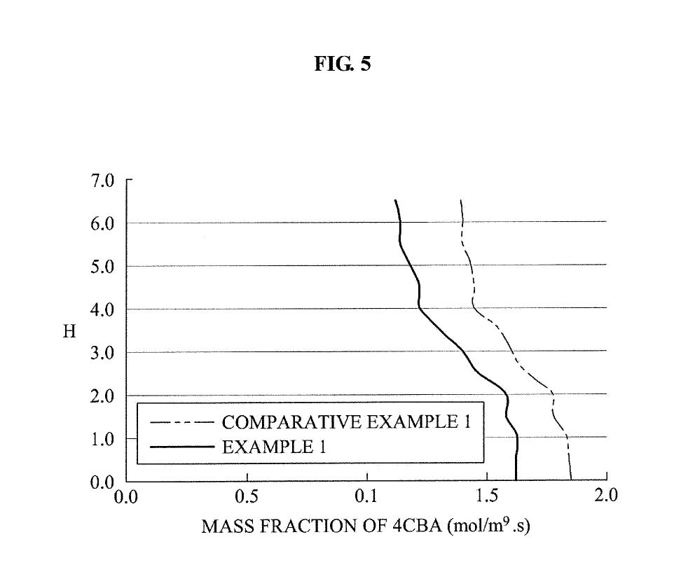

A result of measuring a fraction of an intermediate, 4-CBA, remaining in the reactors of Example 1 and Comparative Example 1 is illustrated in FIG. 5.

As shown in FIG. 5, an amount of the intermediate of Comparative Example 1, 4-CBA, is larger than that of Example 1. Accordingly, a forming rate of TA in Example 1 is higher than that of the Comparative Example 1.

<Measuring a Ratio of CTA in Slurry>

A ratio of CTA being a product of the entire slurry was measured. A concentration of CTA became higher according to the height of the reactor. It is shown that a formation reaction of CTA was started from a lower impeller region and ended in an upper impeller region. In the present invention, a concentration of the slurry is regularly maintained in the upper impeller region and CTA slurry is transferred to a next process through a slurry nozzle.

<Measuring a Mass Ratio of Para-Xylene>

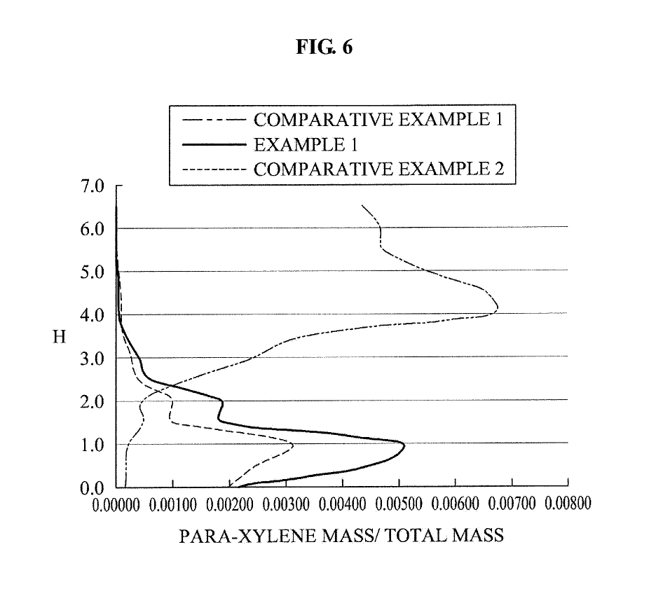

With respect to Example 2, Comparative 1 and 2, a mass fraction of a reactant, para-xylene, was measured. As shown in FIG. 6, a concentration of a liquid reactant, para-xylene, was significantly low in an upper part of a reactor in Example 1, and the liquid reactant, para-xylene, scarcely existed in the upper part of the reactor in Example 1 in comparison with the Comparative Example 1.

Also, in the case of Example 1 and Comparative Example 2, wherein the liquid reactant, para-xylene, was fed from a lower part of the reactor, their mass ratio of para-xylene according to the height of the reactor were similar with each other. It is shown that most of the liquid reactant, para-xylene, fed from the lower part of the reactor was already oxidized before moving to the upper part of the reactor.

<Oxidation of Acetic Acid>

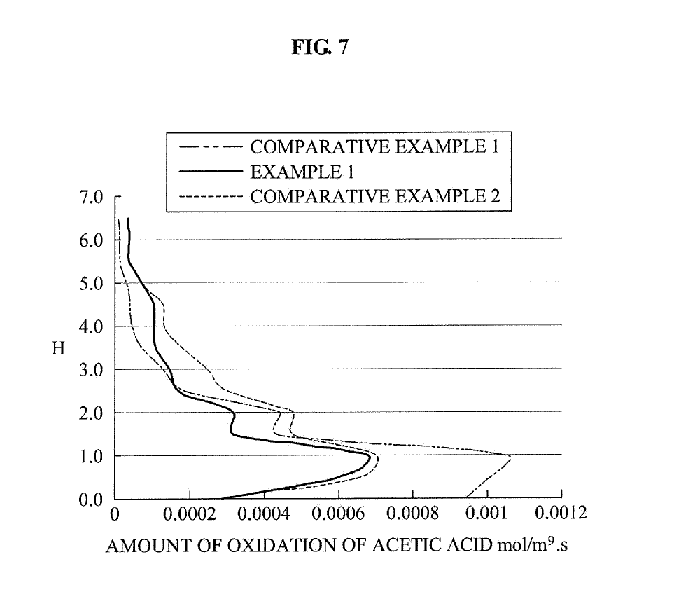

With respect to Example 1, Comparative Example 1 and 2, oxidation of acetic acid was measured. As shown in FIG. 7, it was observed that an amount of oxidation of acetic acid was significantly decreased in Example 1 since a center of a section of an end of a liquid reactant fee pipe was installed to be the same as a center of section of an end of a gas reactant fee pipe and a height of a reflux pipe was controlled.

<Forming Rate of TA>

With respect to Example 1, Comparative Example 1 and 2, formation amount (Kg) of TA was compared when using 100 tons of para-xylene. The result is as shown in Table 1.

TABLE 1

| Example 1 | Comparative 1 | Comparative 2 |
|---|---|---|
| 150.59 | 148.74 | 150.51 |

In the case of Example 1 according to the present invention, a forming rate was increased by about 1.85% in comparison with Comparative Example 1 according to a conventional method, thus 1.85 tons of CTA per 100 tons of para-xylene may be additionally manufactured. Also, in comparison with Comparative Example 2, the forming rate of Example 1 was increased and this was a result of adjusting) a difference between an upper impeller and a lower impeller.

According to the reactor of the present invention, complete stirring is performed inside the reactor, thereby not forming intermediates such as 4-CBA, and the like but forming para-xylene, thus improving a rate of conversion to CTA, and also having an effect of preventing a burning phenomenon of acetic acid used as a solvent.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A para-xylene oxidation reactor for manufacturing crude terephthalic acid (CTA) comprising:
a shaft located in the center of the reactor;
an upper impeller installed in the shaft to perform rotation;
a lower impeller installed in the shaft to perform rotation and located between the upper impeller and a bottom of the reactor;
a liquid reactant feed pipe to feed liquid reactant to the reactor;
a gas reactant feed pipe to feed gas reactant to the reactor; and
a product exhaust pipe to exhaust a product formed inside the reactor to the outside of the reactor,
wherein a center of a section of an end of the liquid reactant feed pipe is located in the same height as a center of a section of an end of the gas reactant feed pipe from a lower part of the reactor.

2. The reactor of claim 1, wherein the center of the section of the liquid reactant feed pipe end is located in a concentrated stirring region of the lower impeller.

3. The reactor of claim 1, wherein the center of the section of the gas reactant feed pipe end is located in a concentrated stirring region of the lower impeller.

4. The reactor of claim 1, wherein a ratio of a height difference between the upper impeller and the lower impeller to a diameter of the impeller is between 1.0 and 1.5.

5. The reactor of claim 1, wherein a ratio of a diameter of the upper/lower impeller to a diameter of the reactor is between 0.4 and 0.5.

6. The reactor of claim 1, wherein a ratio of a height of the lower impeller from the bottom of the reactor to a diameter of the lower impeller is equal to or more than 0.5.

7. The reactor of claim 1, wherein a ratio of a height of the product exhaust pipe from the bottom of the reactor to a height difference between the upper impeller and the lower impeller is between 1.2 and 1.5.

8. The reactor of claim 2, wherein the gas reactant feed pipe end inside the reactor is formed to enable an extension line of the gas reactant feed pipe end to contact a circle formed in a diameter of the lower impeller.

9. The reactor of claim 2, wherein the liquid reactant feed pipe end inside the reactor is formed to enable an extension line of the liquid reactant feed pipe end to contact a circle formed in a diameter of the lower impeller.

10. The reactor of claim 1, further comprising:
a reflux pipe to introduce reflux to the inside of the reactor.

11. The reactor of claim 10, wherein a height of a center of a section of an end of the reflux pipe is the same as a height of a center of a section of the liquid reactant feed pipe end.

12. The reactor of claim 11, wherein the reflux pipe end inside the reactor is formed to enable an extension line of the reflux pipe end to contact a circle formed by a diameter of the lower impeller.
